(19) United States
(12) Patent Application Publication
(10) Pub. No.: US 2023/0389634 A1
(43) Pub. Date: Dec. 7, 2023

(54) MASK HAVING THREE-DIMENSIONAL STRUCTURE

(71) Applicant: AJOU UNIVERSITY INDUSTRY-ACADEMIC COOPERATION FOUNDATION, GYEONGGI-DO (KR)

(72) Inventor: Hyun Jun KIM, Suwon-si (KR)

(73) Assignee: AJOU UNIVERSITY INDUSTRY-ACADEMIC COOPERATION FOUNDATION, GYEONGGI-DO (KR)

(21) Appl. No.: 18/014,110

(22) PCT Filed: Feb. 8, 2022
(86) PCT No.: PCT/KR2022/001918

§ 371 Date: Dec. 30, 2022

(30) Foreign Application Priority Data
Feb. 26, 2021 (KR) 10-2021-0026440
Oct. 18, 2021 (KR) 10-2021-0138696

(51) Int. Cl. A41D 13/11

(52) U.S. Cl. CPC A41D 13/1115; A41D 13/1161

(57) ABSTRACT

The present invention relates to a mask having a three-dimensional structure, wherein the mask may comprise: a mask body; ear loops coupled to both sides of the mask body so as to be worn on a human body; a plurality of wrinkle portions located in the horizontal direction on the mask body; and a surface expansion portion for increasing the surface area of the mask body by having a horizontal support positioned on all or part of the wrinkle portions.

### CROSS-REFERENCE TO RELATED APPLICATION

This application claims priority to and the benefit of Korean Patent Application No. 10-2021-0026440, filed on Feb. 26, 2021, and Korean Patent Application No. 10-2021-0138696, filed on Oct. 18, 2021, the disclosures of which are incorporated herein by reference in their entirety.

### TECHNICAL FIELD

The present invention relates to a mask having a three-dimensional structure, and more specifically to a mask which is comfortable for a user to breathe.

### BACKGROUND ART

Due to the recent coronavirus, masks have become an essential item in our daily life. The mask functions to protect the human body from external harmful substances such as bacteria, yellow dust and fine dust, as well as viruses. In addition, if the mask user is infected with a virus and the like, it functions to prevent the transmission of infectious substances in the body of the infected person to the outside through breathing or droplets.

Meanwhile, in order for the mask to perform an appropriate prevention function, the mask must close both the nose and mouth of the user who wears the mask and adhere to the face so that there is no gap.

However, if the mask is worn correctly, the user has a disadvantage in that breathing becomes uncomfortable. In particular, patients with chronic diseases or heart failure with weak lung or heart function may suffer from hypoxia due to respiratory disorders.

In addition, when the mask is worn in close contact, there is inconvenience such as getting cosmetics on the user's face.

FIGS. 1 and 2 are exemplary diagrams showing the configuration of conventional masks which are currently commercially available, respectively.

The configuration of FIG. 1 is an example of a health mask, and FIG. 2 shows the typical configuration of a KF94 mask.

It includes a mask body 1, ear loop portions 2 for wearing the mask body 1, a nose piece 3 for close contact with the nose bridge of the human body, a chinrest 4 for hanging on the chin of the human body so that the mask body 1 can be in close contact with the human face, and a plurality of wrinkle portions 5 which are formed in the horizontal direction of the mask body 1.

In such a structure, the wrinkle portion 5 serves to fold the mask body 1 in the vertical direction to facilitate storage, and it serves to spread the winkle portion 5 so that it can be used regardless of the size of the face, which is different for each user.

As such, the conventional mask includes only a simple structure for adhering to the face of the human body and technical means for improving versatility, hut does not consider the convenience of breathing for the wearer.

### DISCLOSURE

### Technical Problem

The technical problem to be solved by the present invention in consideration of the above-described problems is to provide a mask having a three-dimensional structure that is easy to breathe, even when wearing a mask according to the correct wearing method.

### Technical Solution

The mask having a three-dimensional structure for solving the above-described problems may include a mask body; ear loops which are coupled to both sides of the mask body so as to be worn on a human body; a plurality of wrinkle portions which are located in the horizontal direction on the mask body; and a surface expansion portion for increasing the surface area of the mask body by having a horizontal support which is positioned on all or part of the wrinkle portions.

In an exemplary embodiment of the present invention, the mask may further include at least one protruding expansion portion which protrudes outward from the mask body such that a concave groove is formed on the surface of the mask body facing the human body.

In an exemplary embodiment of the present invention, the protruding expansion portion may be horn-shaped, column-shaped or frustum-shaped.

In an exemplary embodiment of the present invention, the protruding expansion portion may include a first vertical support for connecting the center of the horizontal support; and a pair of second vertical supports for connecting both ends of the horizontal support, respectively, wherein the first vertical support and the second vertical supports are bent such that the area between the horizontal supports protrudes or is concave in the mask body.

In an exemplary embodiment of the present invention, horizontal supports, which are located at the uppermost and lowermost sides among the horizontal supports, may be disposed at the upper and lower ends of the mask body to serve as a nose piece and a chinrest, respectively.

In an exemplary embodiment of the present invention, the first vertical support and the second vertical support may be bent so as to protrude curvedly in the area between the horizontal supports such that the surface expansion portion has a padding structure.

The mask having a three-dimensional structure according to another aspect of the present invention may include a mask body; ear loops which are coupled to both sides of the mask body so as to be worn on a human body; and at least one protruding expansion portion which protrudes outward from the mask body such that a concave groove is formed on the surface of the mask body facing the human body.

In an exemplary embodiment of the present invention, the protruding expansion portion may be horn-shaped, column-shaped or frustum-shaped.

### Advantageous Effects

The present invention has the effect of preventing the occurrence of side effects, such as respiratory disorders, by facilitating breathing while blocking infection by droplets, when the mask is worn by the correct wearing method.

### DESCRIPTION OF DRAWINGS

FIGS. 1 and 2 are exemplary diagrams of a conventional mask, respectively.

FIG. 3 is a block diagram of the mask having a three-dimensional structure according to a preferred exemplary embodiment of the present invention.

FIGS. 4 to 16 are block diagrams of the mask having a three-dimensional structure according to another exemplary embodiment of the present invention.

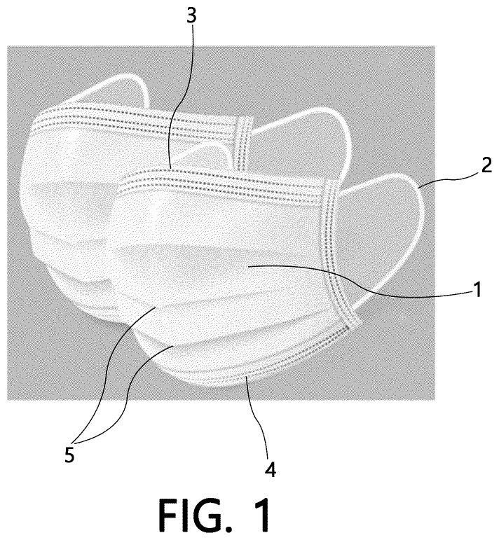

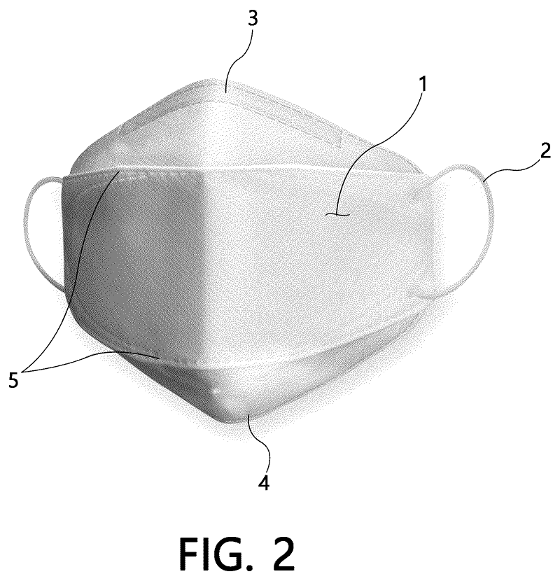

### EXPLANATION OF REFERENCE NUMERALS

| | |
|---|---|
| 10: Mask body | 20: Ear loop |
| 30: Nose piece | 40: Chinrest |
| 50: Wrinkle portion | 60: Surface expansion portion |
| 61: Horizontal support | 62: First vertical support |
| 63: Second vertical support | 70: Protruding expansion portion |
| 71: Support | |

### MODES OF THE INVENTION

Hereinafter, the mask having a three-dimensional structure according to the present invention will be described in detail with reference to the accompanying drawings.

The exemplary embodiments of the present invention are provided to more thoroughly describe the present invention to a person of ordinary skill in the art. The following exemplary embodiments may be modified into various other forms, and the scope of the present invention is not limited to the following exemplary embodiments. Rather, the exemplary embodiments are provided to make the present invention more complete and to fully convey the idea of the present invention to those of ordinary skill in the art.

The terms used herein are used to describe specific exemplary embodiments and are not intended to limit the present invention. As used herein, a singular expression may include a plural expression unless the context clearly indicates otherwise. In addition, the terms “comprise” and/or “comprising,” when used herein, specify the presence of shapes, numbers, steps, operations, members, elements and/or groups thereof mentioned herein and do not preclude the presence of or the possibility of adding one or more shapes, numbers, steps, operations, members, elements and/or groups other than those mentioned. As used herein, the term “and/or” includes any one of the associated listed items and any combination of one or more of the associated listed items.

In the present specification, terms such as first and second are used herein to describe various members, areas and/or portions, but it is obvious that the members, components, areas, layers and/or portions are not limited by the terms. The terms do not indicate a specific order, top or bottom, or merits or demerits and are only used to distinguish one member, area or portion from another member, area or portion. Therefore, a first member, area or portion, which will be described below, may also be referred to as a second member, area or portion without departing from the scope of the present invention.

Hereinafter, the exemplary embodiments of the present invention will be described with reference to the drawings that schematically illustrate the exemplary embodiments of the present invention. In the drawings, for example, modifications of the illustrated shapes may be expected according to production techniques and/or tolerances. Therefore, the exemplary embodiments of the present invention should not be interpreted as being limited to specific shapes of areas illustrated in the drawings and should include, for example, changes in shapes that may occur during production.

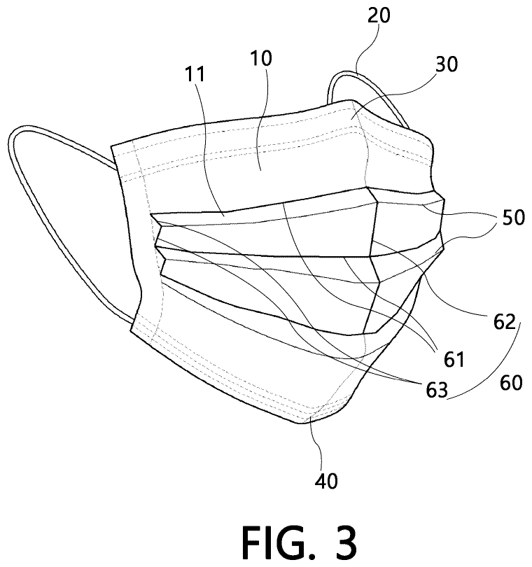

FIG. 3 is a block diagram of the mask having a three-dimensional structure according to a preferred exemplary embodiment of the present invention.

Referring to FIG. 3, the mask of the present invention may include a mask body 10, ear loops 20, a nose piece 30, a chinrest 40, a plurality of wrinkle portions 50, and it may include surface expansion portions 60 on all or part of the plurality of wrinkle portions 50.

The surface expansion portion 60 may include at least one horizontal support 61 which is installed on the wrinkle portion 50, and the mask body 10 between the horizontal supports 61 may include a wrinkle portion 50 in the horizontal direction.

In this configuration, the user wears the mask by placing the ear loops 20 on the ears, placing the nose piece 30 in close contact with the nose bridge and hanging the chinrest 40 on the chin such that the edge of the mask body 10 is in close contact with the face.

In this case, the horizontal supports 61 of the surface expansion portion 60 are spaced apart from the face such that the central part of the mask body 10 is spaced apart from the nose and mouth.

The horizontal support 61 may have a structure in which the center is bent. As such, in the present invention, the surface area of the mask body 10 may be substantially expanded in a state where the mask body 10 is spaced apart from the face by applying the surface expansion portion 60.

The surface area expansion of the mask body 10 is an important factor in determining the amount of air filtered through the mask body 10.

When breathing with the edge in close contact with the face, external air is filtered through the mask body 10 and flows into the space between the mask body 10 and the nose and mouth of the human body, and in this case, this is because more air can flow in at the same time as the area of the mask body is larger.

The present invention increases the surface area of the mask body 10 by applying the surface expansion portion 60 such that breathing is easier.

In addition, by applying the wrinkle portion 50 between the horizontal supports 61, the surface area of the mask body 10 between the horizontal supports 61 may be further increased.

In order to maintain the wrinkle portion 50, a first vertical support 62 for connecting the centers of the horizontal supports 61 and a second vertical support 63 for connecting both ends of the horizontal supports 61 to each other may be considered.

The first vertical support 62 and the second vertical support 63 preferably have a structure in which the wrinkle portion 50 protrudes more outward than the horizontal supports, or conversely, the horizontal support 61 protrudes more outward than the wrinkle portion 50, respectively.

The horizontal support 61, the first vertical support 62 and the second vertical support 63 may use a material that is curved or bent when pressed in order to prevent damage to the human body while maintaining a certain degree of rigidity. For example, a resin tube may be used.

The first vertical support 62 is longer than the second vertical support 63 in length, and the length between the bent parts is also longer.

In addition, the surface expansion portion 60 may have an appropriate elastic restoring force.

As illustrated in FIG. 3, the surface extension area 11 of the mask body 10 expanded by the surface expansion portion 60 may have a protruding or retracted shape in a triangular cross-section.

That is, the surface expansion portion 11 may have a triangular prism shape.

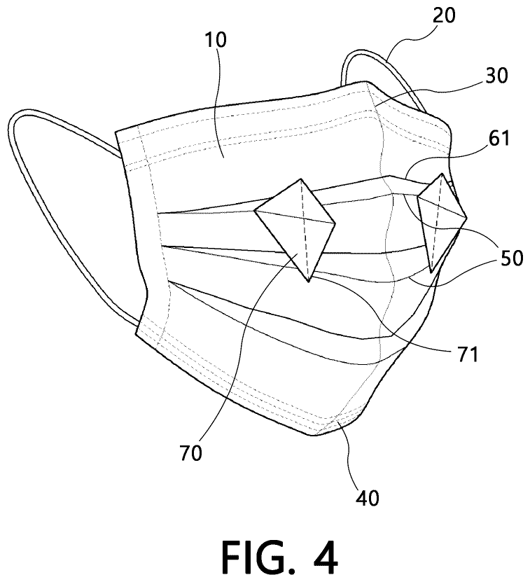

FIG. 4 is another exemplary block diagram of the mask having a three-dimensional structure according to another exemplary embodiment of the present invention.

Referring to FIG. 4, as described above, it may further include a protruding expansion portion 70 for expanding the surface area of the mask body 10 by the horizontal supports 61 and the wrinkle portion 50 disposed between the horizontal supports 61, and additionally for protruding outward in a part of the mask body.

The protruding expansion portion 70 protrudes from the mask body 10 and serves to substantially increase the surface area of the mask body 10 by the surface area of the protruding expansion portion 70. The protruding expansion portion 70 may protrude outward from the surface of the mask body 10, and in this case, one surface of the mask body 10 facing the face has the same shape as the shape of the protruding expansion portion 70 to create a concave space.

The protruding expansion portion 70 may have a triangular pyramid shape as illustrated in FIG. 4, and in this case, a support 71 is used to maintain the triangular pyramid shape.

In this case, the support 71 may also use the same material as the horizontal support 61.

Although the drawings illustrate examples of using both of the surface expansion portion 60 or the protruding expansion portion 70, it may include only the surface expansion portion 60 or conversely, only the protruding expansion portion 70 as in the example of FIG. 3.

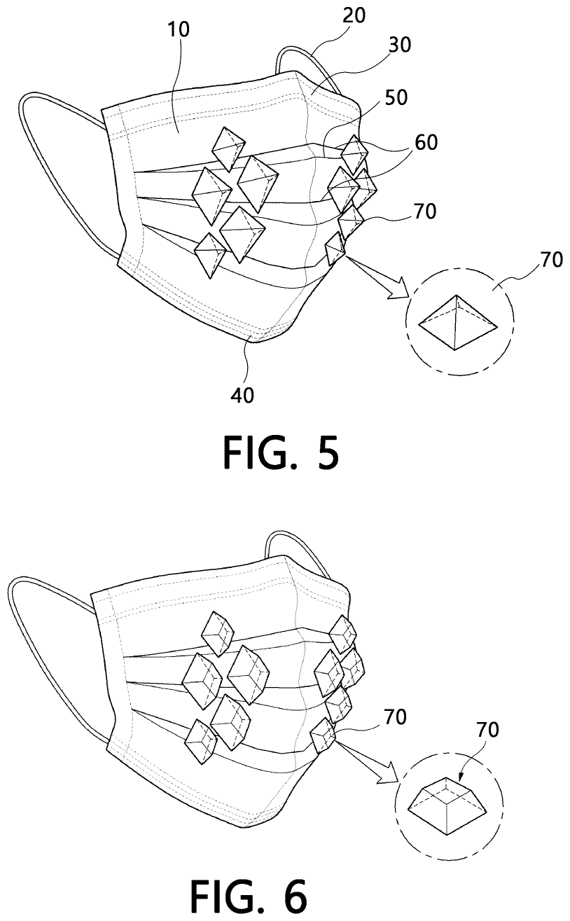

FIGS. 5 to 7 respectively show modified examples of the protruding expansion portion 70 in the mask having a three-dimensional structure according to the present invention.

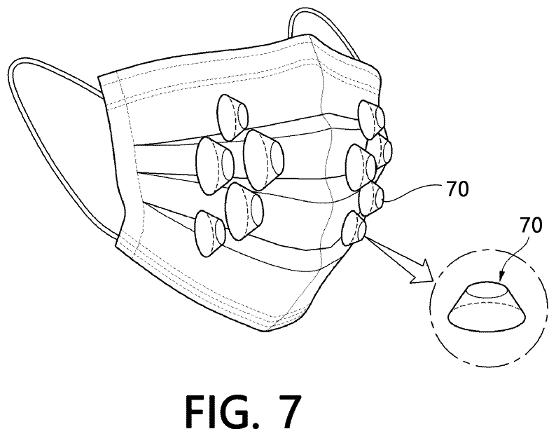

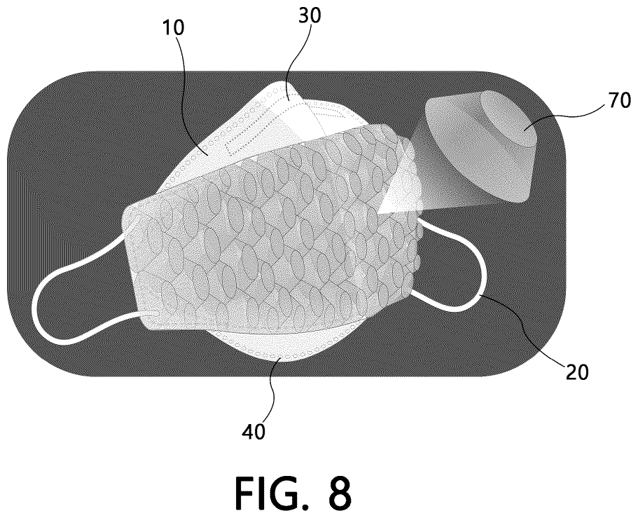

In FIG. 4, the protruding expansion portion 70 in the shape of a triangular pyramid has been illustrated and described, but this is an example, and it may be changed to the form of a quadrangular pyramid (FIG. 5), a tetragonal pyramid (FIG. 6), a truncated cone (FIG. 7) or the like.

As such, the present invention is not limited by the shape of the protruding expansion portion 70.

For example, the protruding expansion portion 70 of the present invention may be in the shape of a polyhedral frustum such as a cone, a cylinder or a triangular frustum, or a polyhedral prism such as a square prism or the like.

In addition, at least one protruding expansion portion 70 may be formed to protrude from the outer surface of the mask body 10.

That is, the protruding expansion portion 70 is not limited to the number and size, and may be manufactured by adjusting the number and size as necessary.

However, the size of the protruding expansion portion 70 formed in the center of the mask body 10 may be larger than the size of the protruding expansion portion 70 formed at the edge of the mask body 10.

This maximizes the surface area of the mask body 10 during respiration to maximize the amount of air inhaled per unit time, and moreover, this is to prevent a part of the field of view from being restricted by the protruding expansion portion 70 protruding from the edge side or to prevent interference from occurring during movement.

FIG. 8 is a block diagram of the mask according to another exemplary embodiment of the present invention.

As illustrated herein, in the present invention, the protruding expansion portions 70 may be densely arranged on the front part of the mask body 10.

Although FIG. 8 illustrates an example in which the truncated cone-shaped protruding expansion portions 70 are densely arranged, the protruding expansion portions 70 in the shape of a column, such as a cylinder, a horn such as a cone, a polyhedral column, a polyhedral horn and a polyhedral truncated cone may be disposed densely.

In particular, the protruding expansion portions 70 which are densely arranged on the same mask body 10 may improve the degree of integration by varying the size of the bottom part for each location, and thus may increase the effective area of the mask body 10 to the maximum.

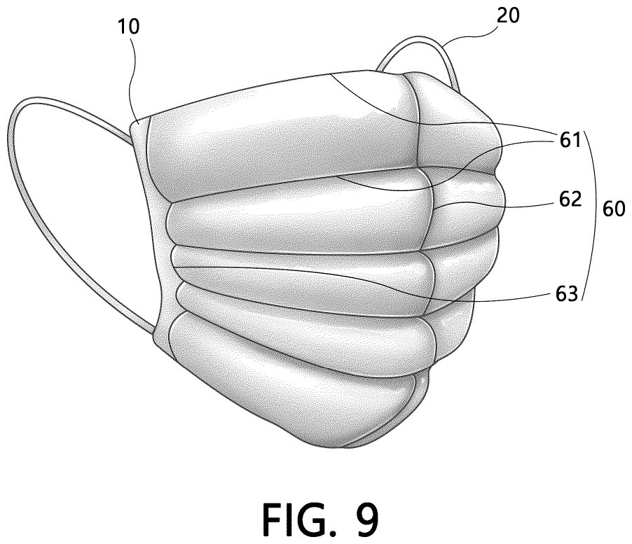

FIG. 9 is a block diagram of the mask according to another exemplary embodiment of the present invention.

Referring to FIG. 9, the present invention uses a plurality of horizontal supports 61 without forming a wrinkle portion, but the horizontal supports 61 are located at the top and bottom of the mask body 10 such that they can serve as both the nose piece and the chinrest, and are disposed at predetermine intervals on the mask body 10 between the horizontal supports 61 which are positioned at the upper and lower ends thereof.

In addition, the centers of the horizontal supports 61 which are disposed as above are connected to each other by the first vertical supports 62, and both end parts are connected to each other by the second vertical supports 63.

An example of such a structure is similar to the configuration example of FIG. 3 described above, but the first vertical support 62 and the second vertical support 63 are convexly curved outwardly in the area between the horizontal supports 61, and thus, it is possible to increase the effective area of the mask body 10.

In this case, the plurality of horizontal supports 61 may have the longest length of the horizontal support which is positioned at the center, and gradually decrease in length toward the upper and lower sides.

Therefore, as illustrated in FIG. 9, the convex structure in the shape of a semi-circular column exhibits an appearance in a stacked form, and the area of the mask body may be increased to provide an overall beautiful appearance and to facilitate breathing.

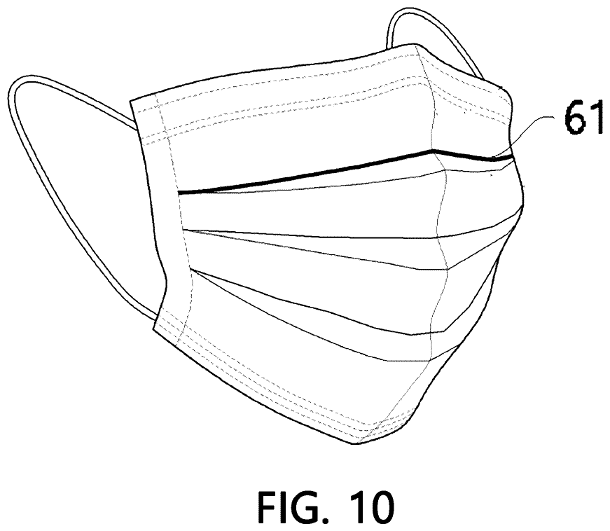

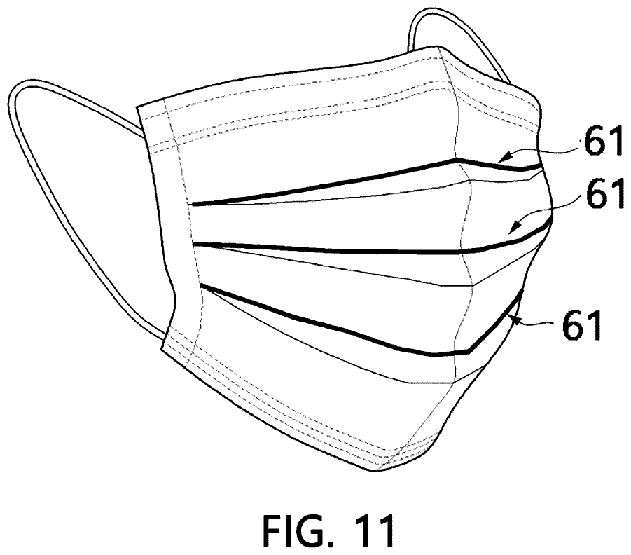

FIGS. 10 and 11 are block diagrams of the mask having a three-dimensional structure according to another exemplary embodiment of the present invention.

As illustrated herein, the present invention may be configured such that the horizontal support 61 is disposed only on the upper side of the plurality of wrinkle portions 50 (FIG. 10), and horizontal supports 61 are positioned on both sides of the upper and lower sides such that the wrinkle portions 50 are disposed therebetween, and horizontal supports 61 may be installed in the center between the horizontal supports 61 installed on both sides of the upper and lower sides to expand the surface of the mask.

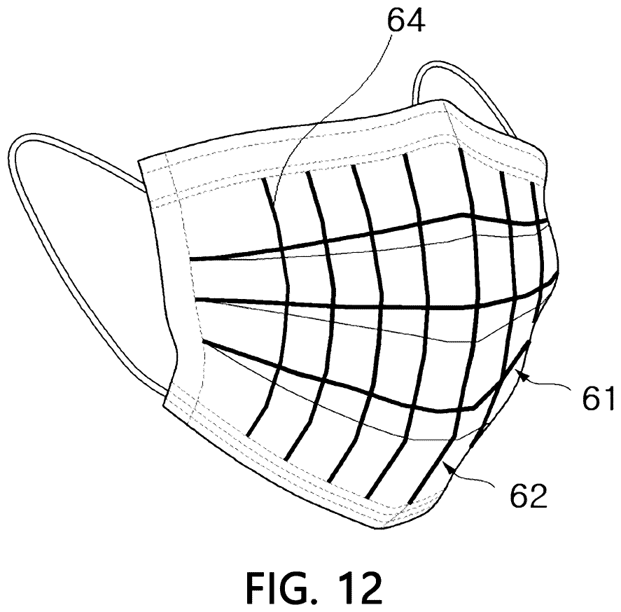

FIG. 12 is another exemplary diagram of the present invention.

Referring to FIG. 12, the present invention uses a plurality of horizontal supports 61, and includes first vertical supports 63 for connecting the centers of the plurality of horizontal supports 61, and it may further include third vertical supports 64 which are disposed at predetermined intervals on both sides from the center of the horizontal support 61.

In this way, a plurality of vertical supports may be used as necessary, and the surface area may be expanded by forming a mesh structure.

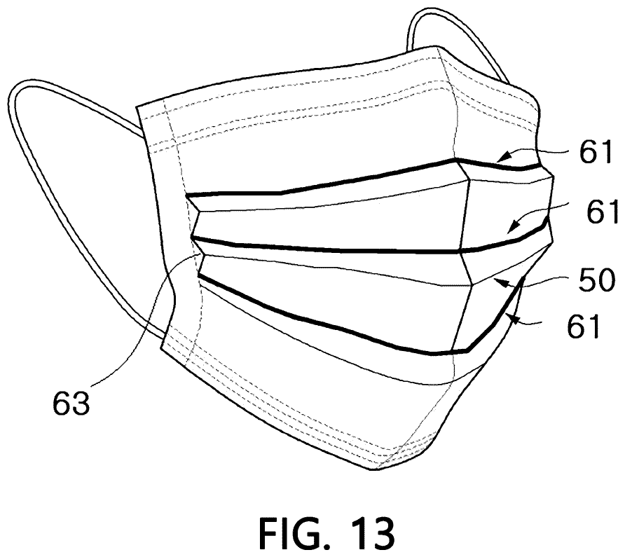

FIG. 13 is another exemplary diagram of the present invention.

The other configuration is similar to the example illustrated in FIG. 11, but the second vertical support 63 is used, and by applying the second vertical support 63 in a bent structure, the mask may be easily folded, and the surface area of the mask may be expanded by protruding a part of the wrinkle portion 50 when it is unfolded.

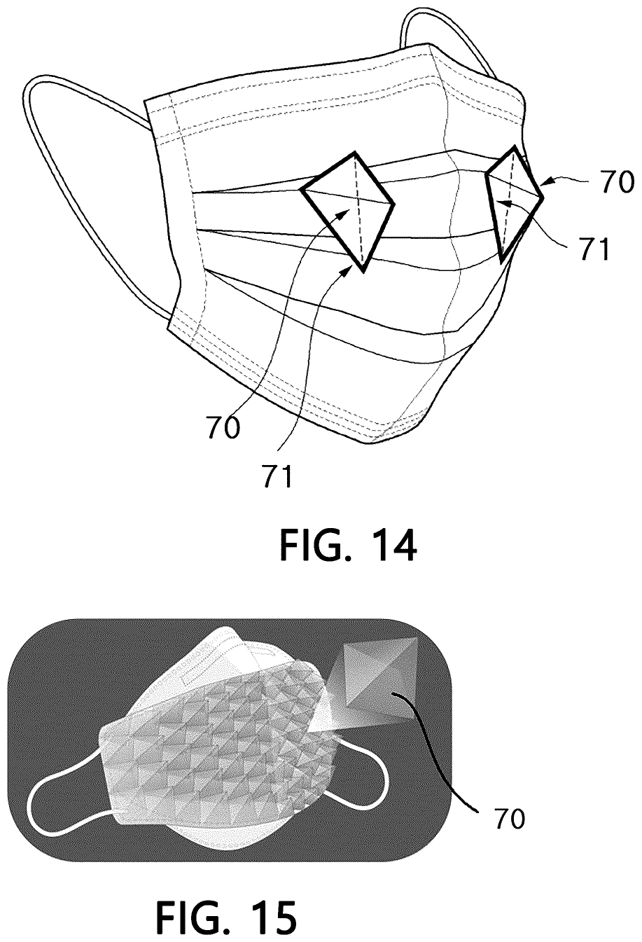

FIG. 14 is another exemplary diagram of the present invention, and similar to the structure of FIG. 4 above, the surface area is increased by using the triangular pyramid-shaped protruding expansion portion 70 using the support 71.

The difference from FIG. 4 is that the surface expansion portion 60 is not used, and only the protruding expansion portion part 70 is applied.

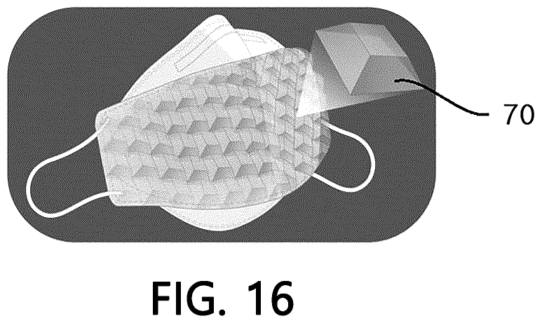

FIGS. 15 and 16 are respectively other exemplary diagrams of the present invention, and are examples of configurations in which the protruding expansion portions are densely arranged as described above with respect to FIG. 8.

The protruding expansion portion 70 may be changed into the shape of a quadrangular pyramid (FIG. 15) and a quadrangular truncated pyramid (FIG. 16).

It will be apparent to those of ordinary skill in the art that the present invention is not limited to the above exemplary embodiments and may be variously changed and modified within the scope without departing from the technical gist of the present invention.

### INDUSTRIAL APPLICABILITY

Since the present invention proposes a mask structure that allows the wearer to breathe more easily while wearing the mask by using the laws of nature, it has industrial applicability.

1. A mask having a three-dimensional structure, comprising:
a mask body;
ear loops which are coupled to both sides of the mask body so as to be worn on a human body;
a plurality of wrinkle portions which are located in the horizontal direction on the mask body; and
a surface expansion portion for increasing the surface area of the mask body by having a horizontal support which is positioned on all or part of the wrinkle portions.

2. The mask of claim 1, further comprising:
at least one protruding expansion portion which protrudes outward from the mask body such that a concave groove is formed on the surface of the mask body facing the human body.

3. The mask of claim 2, wherein the protruding expansion portion is horn-shaped, column-shaped or frustum-shaped.

4. The mask of claim 1, wherein the protruding expansion portion comprises:
a first vertical support for connecting the center of the horizontal support; and
a pair of second vertical supports for connecting both ends of the horizontal support, respectively,
wherein the first vertical support and the second vertical supports are bent such that the area between the horizontal supports protrudes or is concave in the mask body.

5. The mask of claim 4, wherein horizontal supports, which are located at the uppermost and lowermost sides among the horizontal supports, are disposed at the upper and lower ends of the mask body to serve as a nose piece and a chinrest, respectively.

6. The mask of claim 5, wherein the first vertical support and the second vertical support are bent so as to protrude curvedly in the area between the horizontal supports such that the surface expansion portion has a padding structure.

7. A mask having a three-dimensional structure, comprising:
a mask body;
ear loops which are coupled to both sides of the mask body so as to be worn on a human body; and
at least one protruding expansion portion which protrudes outward from the mask body such that a concave groove is formed on the surface of the mask body facing the human body.

8. The mask of claim 7, wherein the protruding expansion portion is horn-shaped, column-shaped or frustum-shaped.
